(19) United States
(12) Patent Application Publication
(10) Pub. No.: US 2016/0371169 A1
(43) Pub. Date: Dec. 22, 2016

(54) USE CASE FINGERPRINTING AND CAPTURE STORE

(71) Applicant: Microsoft Technology Licensing, LLC, Redmond, WA (US)

(72) Inventors: Yong Guo, Bellevue, WA (US); Madhavan Kesavan, Redmond, WA (US); Christian Andreas Gschwend, Seattle, WA (US)

(21) Appl. No.: 14/742,636

(22) Filed: Jun. 17, 2015

(51) Int. Cl. G06F 11/36; G06F 17/30; G06F 3/0482; G06F 17/22; G06F 3/0484

(52) U.S. Cl. CPC G06F 11/3612; G06F 17/2247; G06F 3/04842; G06F 3/0482; G06F 17/30256; G06F 17/30277; G06F 17/30554

(57) ABSTRACT

Various technologies described herein pertain to evaluating a state of a computer-executable application. User interface control information for opened graphical user interface windows of the computer-executable application can be captured during execution of the computer-executable application and used to generate a user interface fingerprint identifier. Additionally, an event log of the computer-executable application can be captured during the execution of the computer-executable application and used to generate an event fingerprint identifier. A global fingerprint identifier that maps to the state of the computer-executable application can be determined based on the user interface fingerprint identifier and the event fingerprint identifier. A query (including the global fingerprint identifier) for execution by a capture store computing system can be generated. Responsive to the execution of the query, a series of user interface captures specified by a use case can be received from the capture store computing system and displayed.

### BACKGROUND

Enterprises oftentimes provide technical support for computer-executable applications. A common scenario involves an error message being outputted by a computer-executable application via a graphical user interface. Following this scenario, conventional approaches for mitigating a problem causing the error message may be problematic and ineffective. For instance, a user of the computer-executable application may attempt to identify the problem and find a solution by performing a search based on context supplied by the error message (e.g., use the error message as a query inputted to a search engine). According to another example, the user may contact a support agent of an enterprise to obtain assistance; thus, the user and the support agent can communicate to attempt to identify the problem to allow the support agent to determine the solution. However, levels of technical understanding of users may vary, which can impact accuracy of problem descriptions. Accordingly, the above noted approaches can be inefficient, inaccurate, and time-consuming.

Moreover, conventional approaches for transferring of product knowledge from a product team that designs, develops, tests, etc. a computer-executable application to a support team (for use in connection with technical support) after release of the computer-executable application is oftentimes inefficient. For instance, solution assets such as knowledge base articles may be created reactively and/or based on known issues when employing conventional approaches. Further, transfer of product use cases and knowledge from product teams to support teams may be based on documents and meetings. Accordingly, traditional approaches for transfer of product knowledge can be based on human understanding, where different people may have different understanding. Further, product development data oftentimes is unable to be leveraged by support teams with conventional approaches. Thus, coverage of the knowledge transfer of possible error scenarios may be limited with traditional approaches. Moreover, support teams often recreate use cases, which may be time intensive and costly; such costs may also increase as release cycles for computer-executable applications become shorter.

### SUMMARY

Described herein are various technologies that pertain to evaluating a state of a computer-executable application. User interface control information for opened graphical user interface windows of the computer-executable application can be captured during execution of the computer-executable application. Moreover, a user interface fingerprint identifier can be generated based on the user interface control information. Additionally, an event log of the computer-executable application can be captured during the execution of the computer-executable application. An event fingerprint identifier can be generated based on the event log. Further, a global fingerprint identifier that maps to the state of the computer-executable application can be determined based on the user interface fingerprint identifier and the event fingerprint identifier.

According to various embodiments, a query for execution by a capture store computing system can be generated, where the query can include the global fingerprint identifier that maps to the state of the computer-executable application. Responsive to the execution of the query by the capture store computing system, a series of user interface captures can be received from the capture store computing system. The series of the user interface captures can be specified by a use case, where the use case corresponds to the state of the computer-executable application. Further, the series of the user interface captures can be displayed via a display screen.

Pursuant to various embodiments, a capture store computing system can include user interface captures for a computer-executable application and use cases for the computer-executable application. A user interface capture can include a screen capture of a graphical user interface window and metadata that specifies control properties for the graphical user interface window. Further, the use cases can specify respective groups of the user interface captures (e.g., respective series of user interface captures). The capture store computing system can receive a request for a use case, and identify the use case based on the request. Moreover, responsive to the request, the capture store computing system can transmit a group of user interface captures specified by the use case identified based on the request.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a functional block diagram of an exemplary system that performs use case fingerprinting for a computer-executable application.

FIG. 2 illustrates an exemplary user interface capture upon which user interface fingerprinting can be performed by a user interface interrogation component of a contextual fingerprinting system.

FIG. 3 illustrates an exemplary application stack of a computer-executable application.

FIG. 4 illustrates an exemplary diagram depicting relationships between identifier described herein.

FIG. 5 illustrates a functional block diagram of an exemplary system that identifies and utilizes a global fingerprint identifier corresponding to a state of a computer-executable application.

FIG. 6 illustrates a functional block diagram of an exemplary system that utilizes a global fingerprint identifier that maps to a state of the computer-executable application to retrieve technical support data from a capture store computing system.

FIG. 7 illustrates a functional block diagram of an exemplary system that includes a capture store computing system.

FIG. 8 illustrates an exemplary graphical user interface for accessing user interface captures retained by a capture store computing system using a namespace tree.

FIG. 9 is a flow diagram that illustrates an exemplary methodology of controlling presentation of a use case based on a state of a computer-executable application.

FIG. 10 illustrates an exemplary computing device.

FIG. 11 illustrates an exemplary computing system.

### DETAILED DESCRIPTION

Various technologies pertaining to fingerprinting of computer-executable application state and utilization of a capture store computing system that includes user interface captures and use cases for the computer-executable application are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

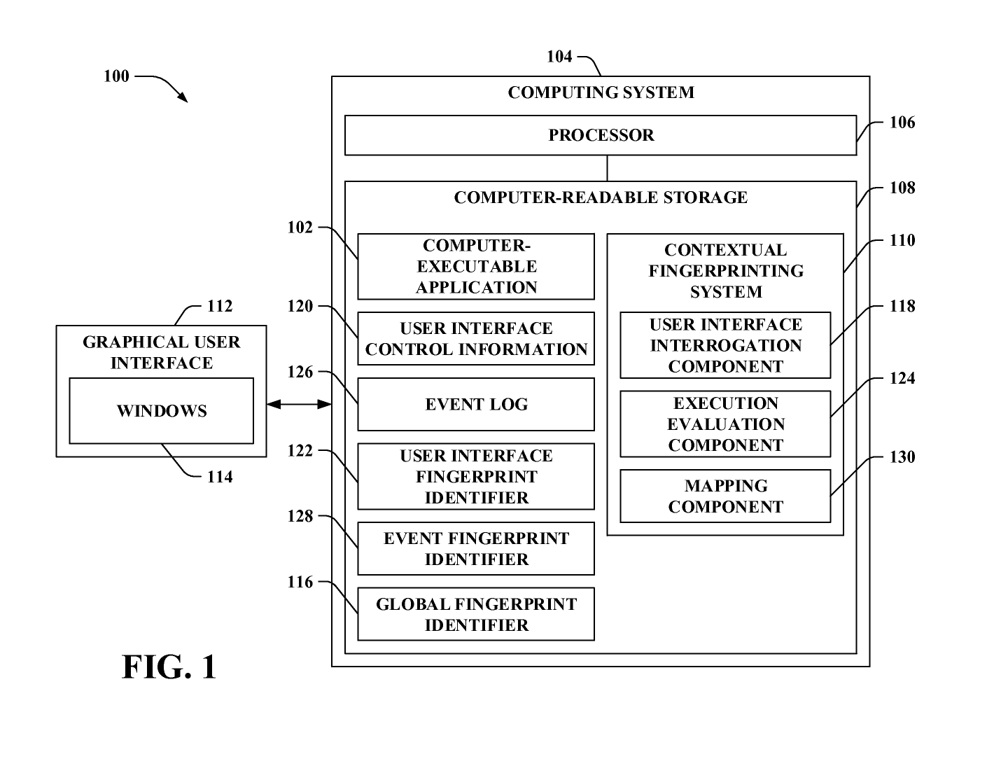

Referring now to the drawings, FIG. 1 illustrates a system 100 that performs use case fingerprinting for a computer-executable application 102. The system 100 includes a computing system 104. The computing system 104 includes at least one processor 106 and computer-readable storage 108. The processor 106 is configured to execute instructions loaded into the computer-readable storage 108 (e.g., one or more systems loaded into the computer-readable storage 108 are executable by the processor 106, one or more components loaded into the computer-readable storage 108 are executable by the processor 106, etc.). As described in greater detail herein, the computer-readable storage 108 includes a contextual fingerprinting system 110 configured to evaluate a state of the computer-executable application 102. The contextual fingerprinting system 110 is executable by the processor 106; thus, the computer-readable storage 108 includes instructions configured to evaluate the state of the computer-executable application 102.

Moreover, the computer-readable storage 108 can include the computer-executable application 102. The computer-executable application 102 can be substantially any type of computer-executable application. Examples of the computer-executable application 102 include, but are not limited to, an operating system, a word processing application, an accounting application, a spreadsheet application, a project management application, an e-mail application, a web browser application, a media player, a video game, a media content creation and/or editing application, etc. Although not shown, it is to be appreciated that the computer-executable application 102 can include the contextual fingerprinting system 110. While one computer-executable application is described herein, namely the computer-executable application 102, it is contemplated that the computer-readable storage 108 can include more than one computer-executable application, and the contextual fingerprinting system 110 (or more than one contextual fingerprinting system) can evaluate respective states for such computer-executable applications.

According to various examples, the computing system 104 can be or include a computing device. Pursuant to various illustrations, the computing device can be a desktop computing device, a mobile computing device (e.g., a laptop computing device, a mobile telephone, a smartphone, a tablet computing device, a wearable computing device, a handheld computing device, a portable gaming device, a personal digital assistant, a camera, etc.), a gaming console, an in-vehicle communications and infotainment system, or the like. In accordance with other examples, the computing system 104 can be or include one or more server computing devices. For instance, the computing system 104 can be or include one or more data centers, where a data center includes a plurality of server computing devices. Additionally or alternatively, the computing system 104 can be a distributed computing system.

The computer-executable application 102 can control a graphical user interface 112. The graphical user interface 112 can include one or more opened graphical user interface windows 114 that can be displayable via an output device. Thus, the graphical user interface 112 can be presented by the output device (e.g., a display device, etc.). The output device can be part of the computing system 104. Additionally or alternatively, the output device can be separate from the computing system 104; accordingly, the output device can be in communication with the computing system 104.

The contextual fingerprinting system 110 is configured to evaluate the state of the computer-executable application 102 and generate a global fingerprint identifier 116 that corresponds to the state of the computer-executable application 102. The global fingerprint identifier 116 can be a globally unique identifier corresponding to the state of the computer-executable application 102. According to an example, the computer-executable application 102 can be configured to initiate the contextual fingerprinting system 110 to determine the global fingerprint identifier 116 that maps to the state of the computer-executable application 102.

The contextual fingerprinting system 110 can be configured to utilize the global fingerprint identifier 116 to obtain technical support data (e.g., solution assets, user interface captures, use cases, etc.) pertaining to the state of the computer-executable application 102. For instance, the contextual fingerprinting system 110 can directly retrieve technical support data corresponding to the global fingerprint identifier 116 (e.g., the technical support data can be retrieved from the computer-readable storage 108 of the computing system 104 and/or computer-readable storage of a differing computing system). By way of another example, the contextual fingerprinting system 110 can generate a query that includes the global fingerprint identifier 116; following this example, the query can be executed by a differing computing system (e.g., a capture store computing system, etc.) to retrieve technical support data corresponding to the global fingerprint identifier 116 for presentation by the computing system 104. Pursuant to yet a further example, the contextual fingerprinting system 110 can output the global fingerprint identifier 116; for instance, a technical support agent can be provided with the global fingerprint identifier 116 to enable technical support data corresponding to the global fingerprint identifier 116 to be retrieved. In contrast, conventional approaches for retrieving technical support data commonly rely on users of computer-executable applications searching for technical support data using limited contextual information (e.g., error messages, etc.) or such users communicating with technical support agents to identify states of the computer-executable applications, which may be time consuming, inefficient, and inaccurate.

According to an illustration, the graphical user interface 112 can include an opened graphical user interface window (one of the windows 114) that includes an error message. Thus, the global fingerprint identifier 116 outputted by the contextual fingerprinting system 110 can be indicative of the state of the computer-executable application 102 at a time that the computer-executable application 102 caused the opened graphical user interface window including the error message to be presented. Further following this illustration, the contextual fingerprinting system 110 can be utilized to obtain a solution (e.g., technical support data) based on the global fingerprint identifier 116 to mitigate the problem encountered by the computer-executable application 102 causing the error message.

According to another illustration, the contextual fingerprinting system 110 can be utilized to determine how to use a feature of the computer-executable application 102. Following this illustration, the contextual fingerprinting system 110 can include the global fingerprint identifier 116 as part of a query for technical support data pertaining to use of the feature of the computer-executable application 102. Accordingly, contextually relevant technical support data related to the state of the computer-executable application 102 and describing the use of the feature can be retrieved by the contextual fingerprinting system 110 responsive to the query. For instance, if a control for a feature is currently not selectable in a graphical user interface window, then a query that includes the global fingerprint identifier 116 can be generated to retrieve dependency information that specifies conditions to enable the control for the feature.

By way of example, the contextual fingerprinting system 110 can be a client for a capture store computing system (e.g., a capture store service). For instance, the contextual fingerprinting system 110 can identify the global fingerprint identifier 116 based on the opened graphical user interface windows 114 and contextually launch a user interface capture from the capture store computing system. Moreover, use cases related to the user interface capture in the capture store computing system can be found, and one or more of the use cases can be run as a support video or slideshow.

The contextual fingerprinting system 110 includes a user interface interrogation component 118 configured to capture user interface control information 120 for the opened graphical user interface windows 114 of the computer-executable application 102 during execution of the computer-executable application 102. The user interface control information 120 can include control tree structure information for the opened graphical user interface windows 114. Moreover, the user interface control information 120 can include information that specifies properties of controls in the opened graphical user interface windows 114. A control can be an element of a graphical user interface through which user input for the computer-executable application 102 can be received. A control can convey a particular action or intention to the computer-executable application 102 through user interaction, and can be used to manipulate content, provide user input, navigate within the computer-executable application 102, or execute other preset actions. Examples of controls include check boxes, buttons, text fields, sliders, switches, and so forth.

The user interface interrogation component 118 is further configured to generate a user interface fingerprint identifier 122 based on the user interface control information 120. For example, the user interface interrogation component 118 can evaluate a hash function based on the user interface control information 120 to determine the user interface fingerprint identifier 122. Following this example, the user interface fingerprint identifier 122 can be a hash value based on the user interface control information 120.

The user interface interrogation component 118 can capture the user interface control information 120 from the graphical user interface 112. The user interface interrogation component 118, for instance, can read the user interface control information 120 from the graphical user interface 112 using one or more application programming interfaces (APIs). The graphical user interface 112 can be a control tree; thus, the user interface interrogation component 118 can obtain the control tree structure information for the opened graphical user interface windows 114 from the graphical user interface 112. Moreover, examples of the information that specifies the properties of the controls in the opened graphical user interface windows 114 can include identifiers of controls in the opened graphical user interface windows 114, identifiers of automations, control class names (strings that specify class names for controls in the opened graphical user interface windows 114), and so forth.

The user interface interrogation component 118 can further be configured to remove language-specific user interface control information from the user interface control information 120 captured for the opened graphical user interface windows 114. Accordingly, language-neutral user interface control information remains after removal of the language-specific user interface control information. Thus, the user interface interrogation component 118 can be configured to generate the user interface fingerprint identifier 122 based on the language-neutral user interface control information without the language-specific user interface control information.

By way of illustration, an opened graphical user interface window for the computer-executable application 102 can include an error message. A difference between two error messages resulting from differing causes may be the error strings (e.g., differing error codes) included as part of the error messages; however, two different error messages may have similar error strings. Accordingly, an error message by itself may or may not satisfactorily identify an error. Thus, the user interface interrogation component 118 can capture an error message along with other user interface control information for the opened graphical user interface windows 114 of the computer-executable application 102. For example, a “File cannot be found” error message can be captured along with user interface control information from other opened graphical user interface windows of the computer-executable application 102 (e.g., a file open dialog box, other graphical user interface windows of the computer-executable application 102). The user interface fingerprint identifier 122 can be generated based on the user interface stack of the computer-executable application 102. Accordingly, context within which an error message occurred can be obtained by the user interface interrogation component 118.

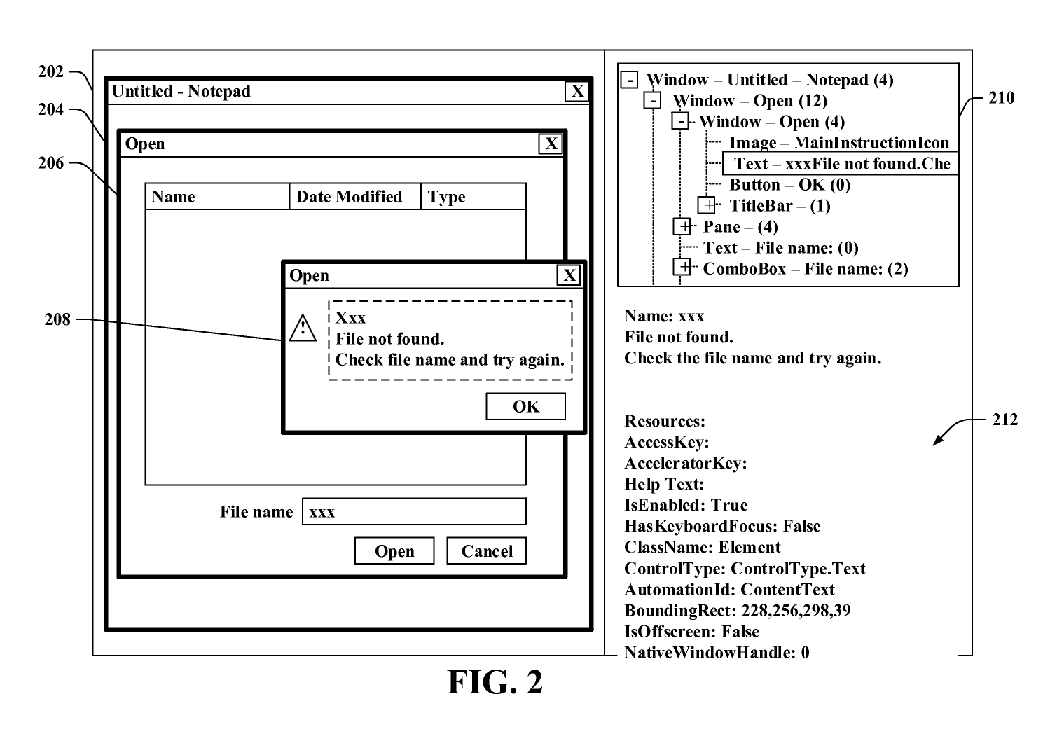

Turning to FIG. 2, illustrated is an exemplary user interface capture upon which user interface fingerprinting can be performed by the user interface interrogation component 118 of the contextual fingerprinting system 110. As illustrated, a region 202 includes opened graphical user interface windows for the computer-executable application 102. The opened graphical user interface windows include a window for the computer-executable application 204 (e.g., Notepad), a file open dialog window 206, and an error message window 208.

Moreover, a region 210 includes control tree structure information for the opened graphical user interface windows. As shown in FIG. 2, text included in the error message window 208 is selected; based on such selection, a region 212 includes information that specifies properties of the text in the error message window 208. As noted above, the control tree structure information for the opened graphical user interface windows and the information that specifies properties of the controls in the opened graphical user interface windows can be used to generate the user interface fingerprint identifier 122.

Reference is again made to FIG. 1. The contextual fingerprinting system 110 further includes an execution evaluation component 124 configured to capture an event log 126 of the computer-executable application 102 during the execution of the computer-executable application 102. The execution evaluation component 124 can capture the event log 126 of the computer-executable application 102 using a debugging engine. Moreover, the execution evaluation component 124 can be configured to generate an event fingerprint identifier 128 based on the event log 126. The event log 126 can be an application stack of the computer-executable application 102, for example. Accordingly, following this example, the execution evaluation component 124 can capture the application stack of the computer-executable application 102 and generate the event fingerprint identifier 128 based on the application stack.

Pursuant to an example, the execution evaluation component 124 can evaluate a hash function based on the event log 126 to determine the event fingerprint identifier 128. Accordingly, the event fingerprint identifier 128 can be a hash value based on the event log 126.

The computer-executable application 102 can have multiple running threads. When an error message is outputted by the computer-executable application 102, a relationship between the error message and its calling function can be stable. For instance, an offset of the calling function can be used to identify a problem encountered by the computer-executable application 102 resulting in the error message being outputted. According to an example, the following can be included in the event log 126 as captured by the execution evaluation component 124.

USER32!MessageBoxW+0x4e

Notepad+0x8038

In the foregoing, the error message is called at Notepad offset 0x8038. Accordingly, Notepad+0x8038 can be used to identify the error.

By way of illustration, the execution evaluation component 124 can employ a debugging engine to capture the application stack (e.g., the event log 126). User mode application threads can be captured utilizing the debugging engine. Moreover, predefined rules can be used by the execution evaluation component 124 to filter out threads related to an error. Further, the event fingerprint identifier 128 can be generated by the execution evaluation component 124 based on an application stack of an error thread.

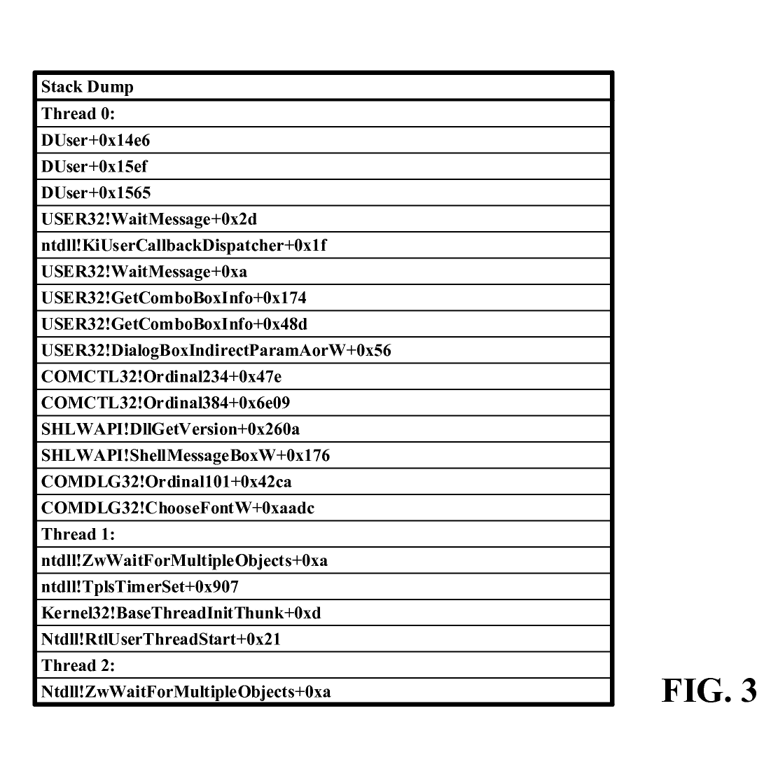

Turning to FIG. 3, illustrated is an exemplary application stack of a computer-executable application (e.g., the computer-executable application 102). As described herein, the execution evaluation component 124 can generate an event fingerprint identifier (e.g., the event fingerprint identifier 128) based on such application stack. It is to be appreciated, however, that the claimed subject matter is not limited to the example depicted in FIG. 3.

Reference is again made to FIG. 1. The contextual fingerprinting system 110 further includes a mapping component 130 configured to determine the global fingerprint identifier 116 that maps to the state of the computer-executable application 102 based on the user interface fingerprint identifier 122 and the event fingerprint identifier 128. The identifiers generated by the user interface interrogation component 118 and the execution evaluation component 124 map to the global fingerprint identifier 116. Moreover, the global fingerprint identifier 116 can map to a solution identifier, thus creating a contextual user problem to solution link.

Accordingly, the contextual fingerprinting system 110 can be configured to determine the global fingerprint identifier 116 that maps to the state of the computer-executable application 102. The global fingerprint identifier 116 can be determined by the contextual fingerprinting system 110 based on the opened graphical user interface windows 114 of the computer-executable application 102 and the event log 126 of the computer-executable application 102. Thus, the contextual fingerprinting system 110 contextually identifies the state of the computer-executable application 102 (e.g., a problem, an error, etc.). Many of the examples described herein describe two independent contexts being used to identify the state of the computer-executable application 102 (e.g., based on the user interface control information 120 and the event log 126). It is to be appreciated, however, that other contexts can additionally or alternatively be used to identify the state of the computer-executable application 102.

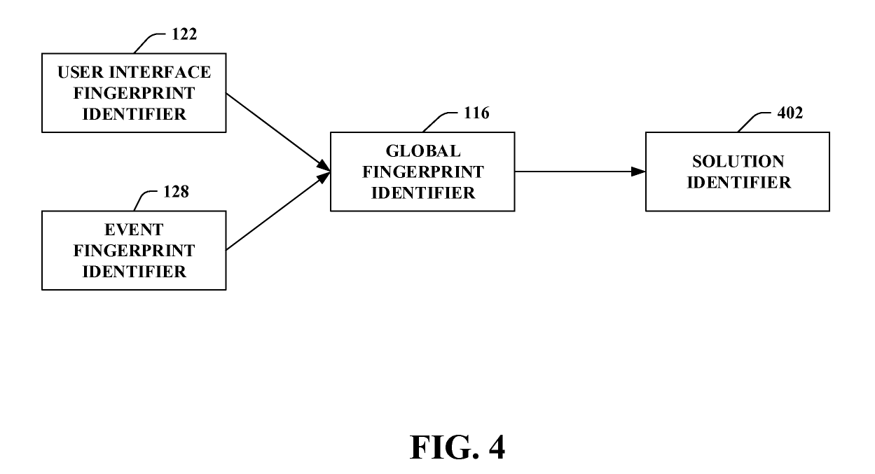

FIG. 4 illustrates an exemplary diagram depicting relationships between identifier described herein. As described herein, a state of the computer-executable application 102 can have multiple contextual fingerprint identifiers, namely, the user interface fingerprint identifier 122 and the event fingerprint identifier 128. Although not shown, it is to be appreciated that other contextual fingerprint identifiers can similarly be generated and utilized. Moreover, the user interface fingerprint identifier 122 and the event fingerprint identifier 128 map to the global fingerprint identifier 116 to identify the state of the computer-executable application (e.g., to identify a problem); such mapping of the user interface fingerprint identifier 122 and the event fingerprint identifier 128 to the global fingerprint identifier 116 is a multiple to one mapping. Moreover, the global fingerprint identifier 116 maps to a solution identifier 402, which is a one to one mapping. The solution identifier 402, for instance, can specify a solution asset.

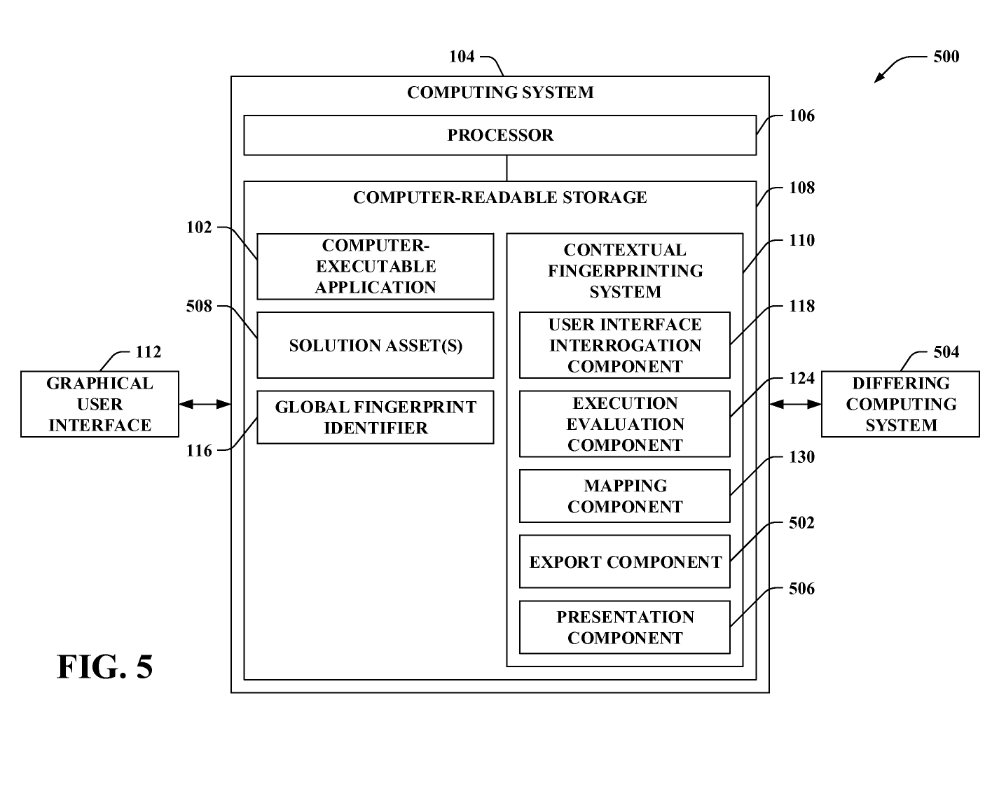

Turning to FIG. 5, illustrated is a system 500 that identifies and utilizes the global fingerprint identifier 116 corresponding to the state of the computer-executable application 102. The system 500 includes the computing system 104. The computing system 104 further includes the contextual fingerprinting system 110, which includes the user interface interrogation component 118, the execution evaluation component 124, and the mapping component 130. According to an example, the contextual fingerprinting system 110 can be a standalone tool for identifying the state of the computer-executable application 102.

Moreover, the contextual fingerprinting system 110 can include an export component 502 configured to transmit the global fingerprint identifier 116 that maps to the state of the computer-executable application 102 to a differing computing system 504. For instance, the differing computing system 504 can be a computing system of a support agent; however, the claimed subject matter is not so limited. Thus, the differing component system 504 can receive the global fingerprint identifier 116 (e.g., to enable the differing computing system 504 to retrieve technical support data corresponding to the state of the computer-executable application 102 that maps to the global fingerprint identifier 116, to recreate the state of the computer-executable application 102 that maps to the global fingerprint identifier 116, etc.).

Moreover, the contextual fingerprinting system 110 can include a presentation component 506. The global fingerprint identifier 116 can map to a solution identifier that specifies a solution asset from a set of solution asset(s) 508. The solution asset(s) 508, for instance, can include knowledge base articles and so forth. Accordingly, the presentation component 506 can be configured to retrieve a solution asset based on the global fingerprint identifier 116 (e.g., specified by the solution identifier that maps to the global fingerprint identifier 116) and output the solution asset (e.g., via a display screen).

According to an example, the computer-readable storage 108 can include the solution asset(s) 508 (or a portion thereof). Additionally or alternatively, the differing computing system 504 or a disparate computing system (not shown) can include the solution asset(s) 508 (or a portion thereof). Thus, the presentation component 506 can retrieve a solution asset that maps to the global fingerprint identifier 116 from a remote computing system (e.g., the differing computing system 504, a disparate computing system, etc.) for presentation.

After the contextual fingerprinting system 110 determines the global fingerprint identifier 116, the presentation component 506 can attempt to map the global fingerprint identifier 116 to a solution asset in the set of solution asset(s) 508. For example, the presentation component 506 can directly identify and launch a knowledge base article based on the global fingerprint identifier 116. If an existing solution asset mapping to the global fingerprint identifier 116 does not exist in the set of solution asset(s) 508, the global fingerprint identifier 116 can be used to find and launch a user interface capture from a capture store computing system as described below in greater detail. Moreover, it is contemplated that related use cases that include the user interface capture can be identified and played back via such scenario.

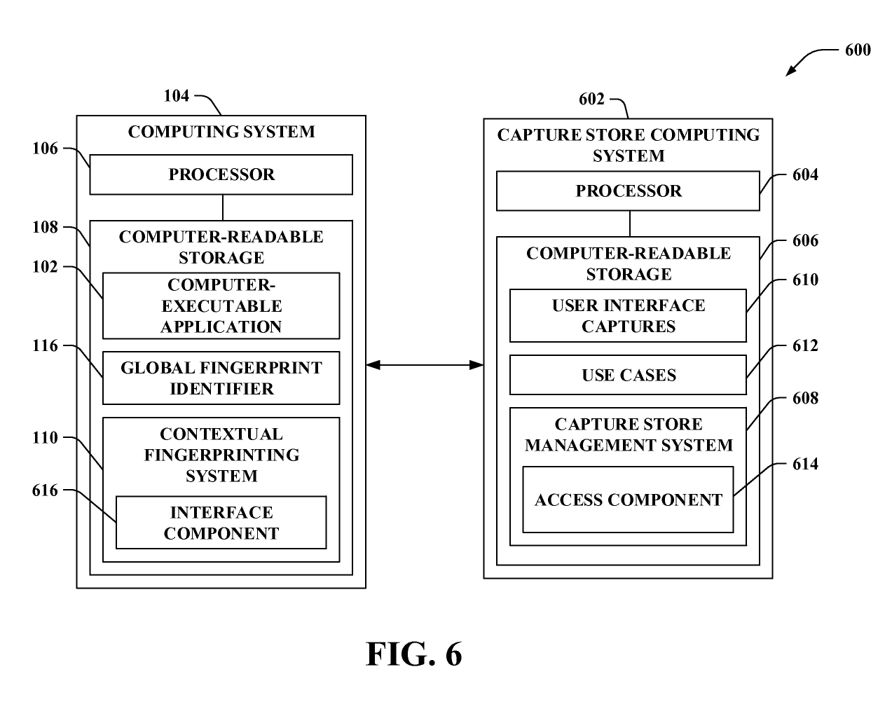

Turning to FIG. 6, illustrated is a system 600 that utilizes the global fingerprint identifier 116 that maps to the state of the computer-executable application 102 to retrieve technical support data from a capture store computing system 602. The system 600 includes the computing system 104 (which includes the contextual fingerprinting system 110 that determines the global fingerprint identifier 116) and the capture store computing system 602.

The capture store computing system 602 includes at least one processor 604 and computer-readable storage 606. The processor 604 is configured to execute instructions loaded into the computer-readable storage 606 (e.g., one or more systems loaded into the computer-readable storage 606 are executable by the processor 604, one or more components loaded into the computer-readable storage 606 are executable by the processor 604, etc.). As described in greater detail herein, the computer-readable storage 606 includes a capture store management system 608 that is executable by the processor 604.

The capture store computing system 602 can be a web service, for example. The capture store computing system 602 can retain user interface related support data for the computer-executable application 102, such as user interface screen captures, use cases, user interface control properties, and so forth. After release of a computer-executable application, a capture store computing system for a product team can be integrated into the capture store computing system 602. The capture store computing system 602 can be managed by two dimensions, namely, user interface capture namespaces and use cases. A use case includes a series of user interface captures. After locating a user interface capture in the capture store computing system 602, related use cases across the user interface capture can be located. Moreover, after locating a user interface control in a user interface capture, related control properties can be identified. User interface screen captures, namespaces, use cases, and control properties can be product knowledge that can be directly used by customer support; however, the claimed subject matter is not so limited.

The computer-readable storage 606 includes user interface captures 610 for the computer-executable application 102 and use cases 612 for the computer-executable application 102. A user interface capture includes a screen capture of a graphical user interface window and metadata that specifies control properties for the graphical user interface window. The use cases 612 specify respective groups of the user interface captures 610. A use case can specify a series of user interface captures from the user interface captures 612 retained in the computer-readable storage 606 of the capture store computing system 602. Further, a use case can be played back as a support video or slide show (e.g., for solving a usage problem, resolving an error, employing a feature, etc.).

The user interface captures 610 include screen captures and metadata. The metadata can be a tree of user interface controls. Each tree node can be a user interface control. According to an example, a user interface tree and controls can be captured using one or more APIs during localization testing of the computer-executable application 102; however, the claimed subject matter is not so limited. Metadata that specifies control properties for a graphical user interface window can include an identifier of a control included in the graphical user interface window, dependency information that includes a condition to enable the control, and a name of the user interface capture (e.g., a user interface string module name). Additionally or alternatively, the metadata can specify a class name of a control, a location of a control, a size of a control, a font name, a font size, an identifier of a resource, and so forth.

As noted above, the metadata of the user interface captures 610 can include dependency information that includes a condition to enable a control. Examples of the dependency information to enable a control include information that indicates that a specified driver is to be installed or information that indicates that a specified component is to be added to enable the control.

A use case specifies a series of user interface captures in the capture store computing system 602. According to an example, at least a portion of the use cases 612 for the computer-executable application 102 can be defined during development of the computer-executable application 102. For instance, before a release of the computer-executable application 102, the use cases 612 that are stable and defined can be included in the capture store computing system 602. The use cases 612 can be created by setting an action or workflow (e.g., click Next button, etc.) on a user interface capture and connecting related user interface captures together in the capture store computing system 602. Moreover, the use cases 612 can be identified by use case identifiers in the capture store computing system 602. A use case identifier can be used for an API of the capture store computing system 602.

During use case creation, user interface test coverage of the capture store computing system 602 can be measured. Further, user interface string language neutral information can be changed per use case since control properties can include location, size, font name, font size information, etc. For example, a user interface capture can have a filename in the user interface string. In a different use case, the filename may be different. Moreover, during use case creation, a filename can be defined for the use case. When playing back the use case, the filename can be replaced on the user interface screen capture. Moreover, instructions can be defined to assist understanding an action. For instance, the instruction can be displayed on top of a user interface screen capture, nearby the action, during playback.

The capture store management system 608 can include an access component 614 configured to receive a request for a use case (e.g., selected from the use cases 612). According to an example, the request for the use case can be received from the computing system 104. Further, the access component 614 can be configured to identify the use case based on the request. Responsive to the request, the access component 614 can be configured to transmit a group of the user interface captures (e.g., from the user interface captures 610) specified by the use case identified based on the request. For instance, the access component 614 can transmit the group of the user interface captures to the computing system 104.

As described herein, the contextual fingerprinting system 110 of the computing system 104 can determine the global fingerprint identifier 116 that maps to the state of the computer-executable application 102 (e.g., the contextual fingerprinting system 110 can include the user interface interrogation component 118, the execution evaluation component 124, and the mapping component 130). Moreover, the contextual fingerprinting system 110 can include an interface component 616 configured to generate a query for execution by the capture store computing system 602, where the query includes the global fingerprint identifier 116. Accordingly, the query can be transmitted from the computing system 104 to the capture store computing system 602.

By way of example, the request received by the access component 614 of the capture store computing system 602 can be the query that includes the global fingerprint identifier 116. The access component 614 can be configured to identify a use case based on the global fingerprint identifier 116 included in the query. Thus, in response to the query, the access component 614 can be configured to transmit a series of user interface captures specified by the identified use case.

Following the aforementioned example, responsive to execution of the query by the capture store computing system 602, the interface component 616 of the contextual fingerprinting system 110 can be configured to receive the series of the user interface captures from the capture store computing system 602 (e.g., the series of the user interface captures can be specified by the use case that corresponds to the state of the computer-executable application 102). Moreover, the interface component 616 can be configured to display the series of the user interface captures (e.g., via a display screen).

Pursuant to another example, the request received by the access component 614 of the capture store computing system 602 can include the query generated by the interface component 616. Following this example, the access component 614 can be configured to identify a user interface capture (from the user interface captures 610) based on the query (e.g., based on the global fingerprint identifier 116 included in the query). Moreover, the access component 614 can be configured to identify a list of use cases (from the use cases 612), where each of the use cases in the list include the user interface capture identified by the access component 614 based on the query. The access component 614 can further be configured to transmit the list of the use cases and the identified user interface capture to the computing system 104.

Continued reference is made to the above example. Responsive to execution of the query by the capture store computing system 602, the interface component 616 can be configured to receive the user interface capture corresponding to the state of the computer-executable application 102 and the list of use cases across the user interface capture. Moreover, the interface component 616 can be configured to receive a selection (e.g., user input) of a particular use case from the list of use cases. Responsive to the selection, the interface component 616 can be configured to transmit an indication of the selection of the particular use case to the capture store computing system 602. The access component 614 can be configured to receive the indication of the selection of the particular use case from the list of use cases. Responsive to receipt of the indication of the selection of use case, the access component 614 can be configured to transmit a group of the user interface captures (e.g., series of user interface captures) specified by the particular use case to the computing system 104. Accordingly, the interface component 616, responsive to the selection, can be configured to receive the series of user interface captures specified by the particular use case from the capture store computing system 602. The interface component 616 can further be configured to display the series of the user interface captures via a display screen.

According to various example (e.g., as shown in FIG. 6), the contextual fingerprinting system 110 of the computing system 104 can be integrated with the capture store computing system 602. If the contextual fingerprinting system 110 is unable to find a solution asset (e.g., the presentation component 506 is unable to retrieve a solution asset as described in FIG. 5), then the interface component 616 can generate a query that includes the global fingerprint identifier 116 for execution by the capture store computing system 602. For instance, the global fingerprint identifier 116 can be used by the capture store computing system 602 to retrieve a user interface capture and/or a use case (e.g., a group of user interface captures specified by the use case). Moreover, a user interface capture can be added to the user interface captures 610 and/or a use case can be added to the use cases 612 retained in the computer-readable storage 606 of the capture store computing system 602 without updating the contextual fingerprinting system 110; rather, a global fingerprint identifier received from the contextual fingerprinting system 110 can be associated with a new user interface capture and/or a new use case added to the capture store computing system 602. It is also contemplated, however, that the capture store computing system 602 need not be integrated with the contextual fingerprinting system 110 in accordance with other examples.

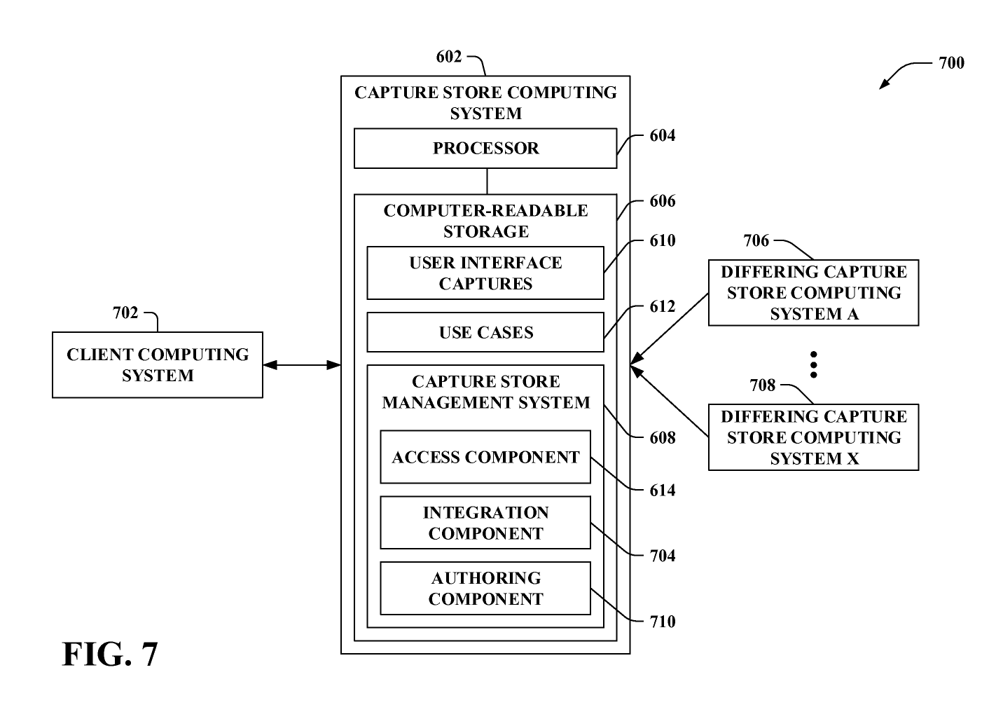

Now turning to FIG. 7, illustrated is a system 700 that includes the capture store computing system 602. The capture store computing system 602 includes the user interface captures 610, the use cases 612, and the capture store management system 608. Moreover, the system 700 includes a client computing system 702 that can receive one or more of the user interface captures 610 and/or one or more of the use cases 612 from the capture store computing system 602.

According to an example, the client computing system 702 can be the computing system 104 (e.g., which includes the contextual fingerprinting system 110, as described in FIG. 6, etc.). However, by way of another example, the client computing system 702 need not include the contextual fingerprinting system 110.

The user interface captures 610 each have a respective corresponding namespace. For example, a namespace for a user interface capture for Application-X can be OperatingSystem/Accessories/Application-X. The namespaces are used to identify the user interface captures 610 (e.g., a first namespace identifies a first user interface capture, a second namespace identifies a second user interface capture, etc.). According to an example, a namespace can be used to reference a user interface capture in an API of the capture store computing system 602.

A namespace tree that includes the namespaces of the user interface captures 610 can be outputted by the client computing system 702 (e.g., displayed via a display screen). Responsive to input received by the client computing system 702, the namespace tree can be navigated to find a given namespace, and the given namespace can be selected to initiate retrieval of a particular user interface capture corresponding to the given namespace from the capture store computing system 602. Thus, the access component 614 of the capture store management system 608 can be configured to receive, from the client computing system 702, an indication of the selection of the given namespace from the namespace tree. Responsive thereto, the access component 614 can be configured to transmit the particular user interface capture to the client computing system 702; the client computing system 702, for instance, can output the particular user interface capture (e.g., via a display screen).

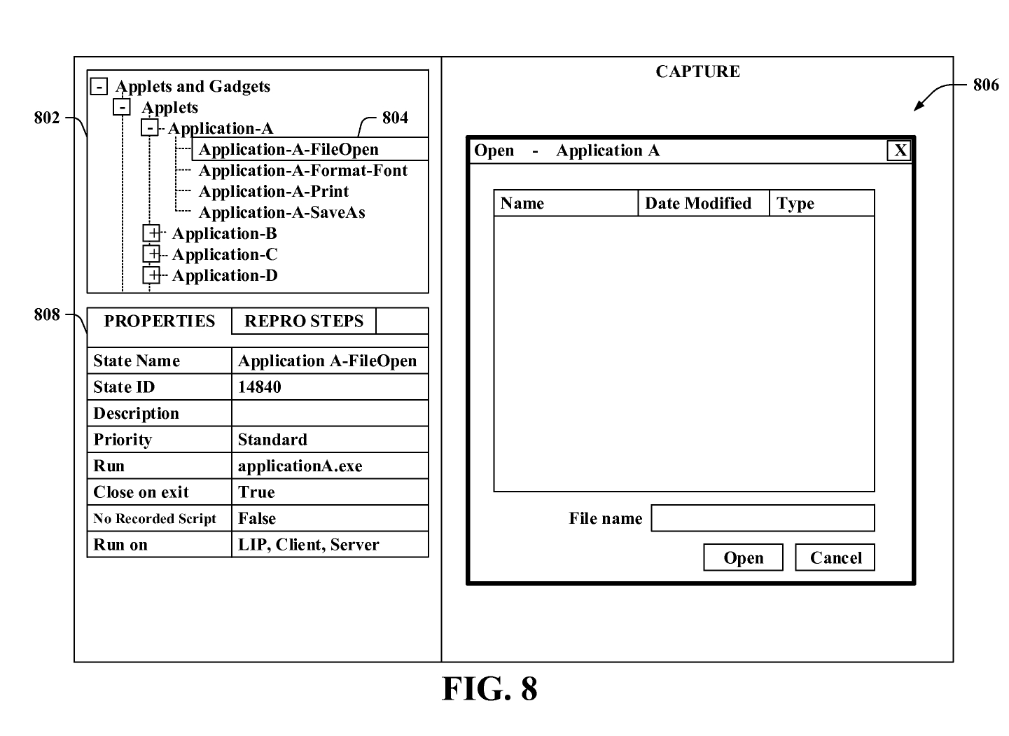

Turning to FIG. 8, illustrated is an exemplary graphical user interface for accessing the user interface captures 610 retained by the capture store computing system 602 using a namespace tree. For instance, the exemplary graphical user interface can be presented by the client computing system 702 of FIG. 7. The graphical user interface includes a region 802 that includes the namespace tree, which can be navigated. A namespace corresponding to a user interface capture in the namespace tree can be selected in the region 802. In the depicted example, a namespace Application-A-FileOpen 804 is selected. Selection of the namespace Application-A-FileOpen 804 can cause a screen capture from the user interface capture for the namespace Application-A-FileOpen 804 to be included in a region 806 of the graphical user interface. Moreover, the selection of the namespace Application-A-FileOpen 804 can cause control properties from the user interface capture for the namespace Application-A-FileOpen 804 to be included in a region 808 of the graphical user interface.

Reference is again made to FIG. 7. Responsive to receipt of the indication of the selection of the given namespace for retrieving the particular user interface capture, the access component 614 can further be configured to identify a list of use cases that include the particular user interface capture. The list of use cases can be transmitted by the access component 614 to the client computing system 702 (e.g., along with the particular user interface capture). The client computing system 702 can output the list of use cases (e.g., via a display screen) and can receive input indicative of a selection of a given use case from the list of use cases. Accordingly, the client computing system 702 can transmit a request for the given use case to the capture store computing system 602. As described herein, the access component 614 of the capture store computing system 602 can receive the request for the given use case, identify the given use case based on the request, and transmit a series of user interface captures specified by the given use case to the client computing system 702.

After a use case is selected on the client computing system 702, the use case can be played back by the client computing system 702 as a support video or slideshow. An action (e.g., next button) can be highlighted during playback based on location and size of information of a control. Moreover, additional instructions can be added on a user interface capture during playback of the use case.

The use cases 612 differ from conventional support videos that are typically unable to be updated after creation. The use cases 612 can be updated after creation. Moreover, the use cases 612 can be language-neutral, and thus, can be created in one language and played back in other languages.

The capture store management system 608 can further include an integration component 704 configured to receive at least a portion of the user interface captures 610 and at least a portion of the use cases 612 for a computer-executable application (e.g., the computer-executable application 102) from one or more differing capture store computing systems. The differing capture store computing systems can include a differing capture store computing system A 706, . . . and a differing capture store computing system X 708, where X can be substantially any integer greater than one (collectively referred to herein as the differing capture store computing systems 706-708). Each of the differing capture store computing systems 706-708 can be substantially similar to the capture store computing system 602; however, the claimed subject is not so limited. Moreover, the integration component 704 can be configured to store the user interface captures for the computer-executable application and the use cases for the computer-executable application received from the differing capture store computing systems 706-708 in the computer-readable storage 606 of the capture store computing system 602.

By way of example, a product team for a first computer-executable application can use one of the differing capture store computing systems 706-708 (e.g., the differing capture store computing system A 706), a product team for a second computer-executable application can use a different one of the differing capture store computing systems 706-708 (e.g., the differing capture store computing system X 708), and so forth. According to an illustration, the differing capture store computing system A 706 can be used by a product team for localization testing of a computer-executable application. Localized user interfaces of the computer-executable application can be captured and saved in computer-readable storage of the differing capture store computing system 706. After release of the computer-executable application, contents of the differing capture store computing system A 706 can be transferred to the capture store computing system 602. Thus, the integration component 704 can receive and store such contents in the computer-readable storage 606 of the capture store computing system 602. Accordingly, product development knowledge can be supplied to the capture store computing system 602 for use in customer support.

The capture store management system 608 can further include an authoring component 710 configured to create a differing use case for a computer-executable application (e.g., the computer-executable application 102). The differing use case can specify a subset of the user interface captures 610. Additionally or alternatively, other user interface captures can be uploaded to the capture store computing system 602 for inclusion as part of the differing use case. Moreover, the authoring component 710 can be configured to store the differing use case for the computer-executable application as part of the use cases 612 in the computer-readable storage 606.

According to another example, one of the differing capture store computing systems 706-708 can be a community capture store computing system. The community capture store computing system can be used for customers communicating problem use cases (e.g., problem reproduction steps) and solution use cases if such solutions are unable to be located in the capture store computing system 602. For instance, a problem use case can be defined in the community capture store computing system using one or more of the user interface captures 610 and/or uploading user interface capture(s) to the community capture store computing system (e.g., if the user interface captures 610 lack such user interface captures). According to an example, links to use cases can be sent between users; for instance, a link to a problem use case can be sent to an expert or to one or more community participants. Moreover, community participants or experts can create a solution use case by using the user interface captures 610 or uploading user interface captures to the community capture store computing system if the user interface captures do not exist. The solution use can be visual solution steps that can be defined on the community capture store computing system. Further, a link can be sent back to the user that provided the problem use case, for instance. Contents of the community capture store computing system can be reviewed, and if approved, community generated use cases and uploaded user interface captures can be integrated into the capture store computing system 602 by the integration component 704.

By way of example, the capture store computing system 602 can support creation of globalized solution automation. For instance, user interface string module names and resource identifiers in a user interface capture control property can be used to write globalized solution automation. Automation can load resource strings from a specific module with the resource identifier during runtime and can generate localized user interface strings on the fly. The foregoing can save time and cost associated with localization and can mitigate errors in localization for automated solution creation.

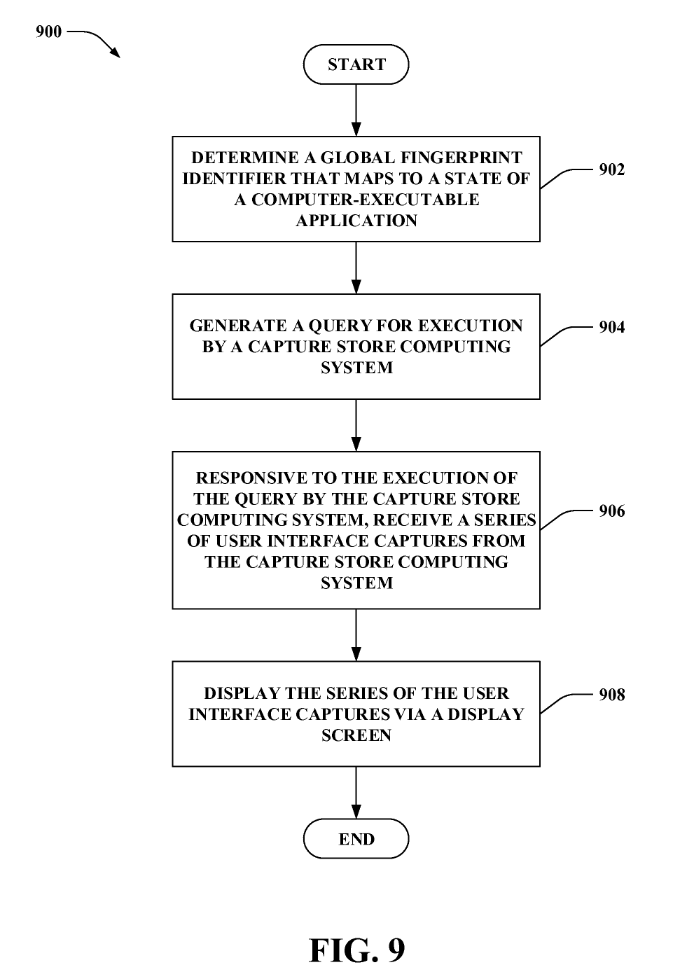

FIGS. 9 illustrates an exemplary methodologies relating to using a state of a computer-executable application to control presentation of a use case. While the methodology is shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

FIG. 9 illustrates a methodology 900 of controlling presentation of a use case based on a state of a computer-executable application. At 902, a global fingerprint identifier that maps to the state of the computer-executable application can be determined. The global fingerprint identifier can be determined based on opened graphical user interface windows of the computer-executable application and an event log of the computer-executable application. At 904, a query for execution by a capture store computing system can be generated. The query can include the global fingerprint identifier. At 906, responsive to the execution of the query by the capture store computing system, a series of user interface captures can be received from the capture store computing system. The series of the user interface captures can be specified by the use case corresponding to the state of the computer-executable application. At 908, the series of the user interface captures can be displayed via a display screen.

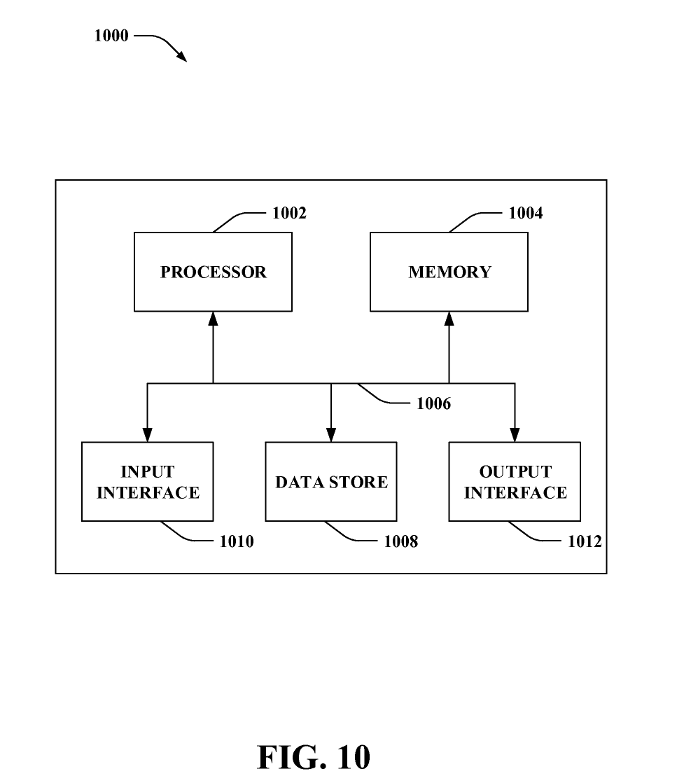

Referring now to FIG. 10, a high-level illustration of an exemplary computing device 1000 that can be used in accordance with the systems and methodologies disclosed herein is illustrated. For instance, the computing device 1000 may be used in a system that evaluates a state of a computer-executable application. By way of another example, the computing device 1000 can be used in a system that retains and distributes user interface captures and use cases. The computing device 1000 includes at least one processor 1002 that executes instructions that are stored in a memory 1004 (e.g., computer-readable storage). The instructions may be, for instance, instructions for implementing functionality described as being carried out by one or more components discussed above or instructions for implementing one or more of the methods described above. The processor 1002 may access the memory 1004 by way of a system bus 1006. In addition to storing executable instructions, the memory 1004 may also store user interface control information, event logs, user interface fingerprint identifiers, event fingerprint identifiers, global fingerprint identifiers, solution assets, user interface captures, use cases, and so forth.

The computing device 1000 additionally includes a data store 1008 that is accessible by the processor 1002 by way of the system bus 1006. The data store 1008 may include executable instructions, user interface control information, event logs, user interface fingerprint identifiers, event fingerprint identifiers, global fingerprint identifiers, solution assets, user interface captures, use cases, etc. The computing device 1000 also includes an input interface 1010 that allows external devices to communicate with the computing device 1000. For instance, the input interface 1010 may be used to receive instructions from an external computer device, from a user, etc. The computing device 1000 also includes an output interface 1012 that interfaces the computing device 1000 with one or more external devices. For example, the computing device 1000 may display text, images, etc. by way of the output interface 1012.

It is contemplated that the external devices that communicate with the computing device 1000 via the input interface 1010 and the output interface 1012 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1000 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1000 may be a distributed system. Thus, for instance, several devices may be in communication by way of a network connection and may collectively perform tasks described as being performed by the computing device 1000.

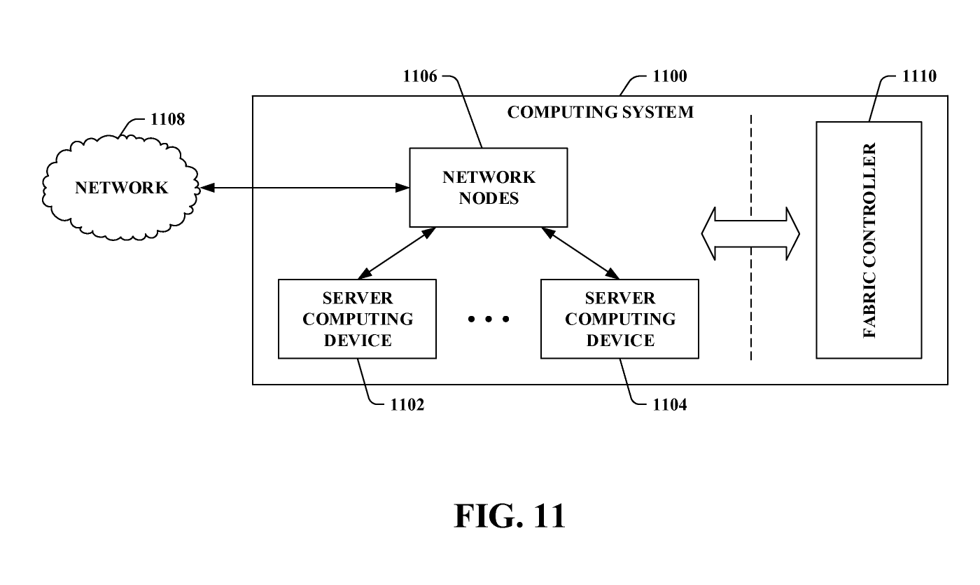

Turning to FIG. 11, a high-level illustration of an exemplary computing system 1100 that can be used in accordance with the systems and methodologies disclosed herein is illustrated. For instance, the computing system 1100 can be or include the computing system 104. Additionally or alternatively, the computing system 104 can be or include the computing system 1100. According to another example, the computing system 1100 can be, include, or be included in the differing computing system 504. By way of yet a further example, the computing system 1100 can be, include, or be included in the capture store computing system 602. In other examples, the computing system 1100 can be, include, or be included in the client computing system 702 or the differing capture store computing systems 706-708.

The computing system 1100 includes a plurality of server computing devices, namely, a server computing device 1102, . . . , and a server computing device 1104 (collectively referred to as server computing devices 1102-1104). The server computing device 1102 includes at least one processor and computer-readable storage; the at least one processor executes instructions that are stored in the computer-readable storage. The instructions may be, for instance, instructions for implementing functionality described as being carried out by one or more components discussed above or instructions for implementing one or more of the methods described above. Similar to the server computing device 1102, at least a subset of the server computing devices 1102-1104 other than the server computing device 1102 each respectively include at least one processor and computer-readable storage. Moreover, at least a subset of the server computing devices 1102-1104 include respective data stores.

Processor(s) of one or more of the server computing devices 1102-1104 can be or include the processor 106. According to another example, processor(s) of one or more of the server computing devices 1102-1104 can be or include the processor 604. Further, computer-readable storage of one or more of the server computing devices 1102-1104 can be or include the computer-readable storage 108. By way of another example, computer-readable storage of one or more of the server computing devices 1102-1104 can be or include the computer-readable storage 606.

The computing system 1100 further includes various network nodes 1106 that transport data between the server computing devices 1102-1104. Moreover, the network nodes 1102 transport data from the server computing devices 1102-1104 to external nodes (e.g., external to the computing system 1100) by way of a network 1108. The network nodes 1102 also transport data to the server computing devices 1102-1104 from the external nodes by way of the network 1108. The network 1108, for example, can be the Internet, a cellular network, or the like. The network nodes 1106 include switches, routers, load balancers, and so forth.

A fabric controller 1110 of the computing system 1100 manages hardware resources of the server computing devices 1102-1104 (e.g., processors, memories, data stores, etc. of the server computing devices 1102-1104). The fabric controller 1110 further manages the network nodes 1106. Moreover, the fabric controller 1110 manages creation, provisioning, de-provisioning, and supervising of virtual machines instantiated upon the server computing devices 1102-1104.

Various examples are now set forth.

### EXAMPLE 1

A computing system, comprising: at least one processor; and computer-readable storage comprising a contextual fingerprinting system configured to evaluate a state of a computer-executable application, the contextual fingerprinting system being executable by the at least one processor, the contextual fingerprinting system comprising: a user interface interrogation component configured to: capture user interface control information for opened graphical user interface windows of the computer-executable application during execution of the computer-executable application; and generate a user interface fingerprint identifier based on the user interface control information; an execution evaluation component configured to: capture an event log of the computer-executable application during the execution of the computer-executable application; and generate an event fingerprint identifier based on the event log; and a mapping component configured to determine a global fingerprint identifier that maps to the state of the computer-executable application based on the user interface fingerprint identifier and the event fingerprint identifier.

### EXAMPLE 2

The computing system according to Example 1, the user interface control information comprises control tree structure information for the opened graphical user interface windows and information that specifies properties of controls in the opened graphical user interface windows.

### EXAMPLE 3

The computing system according to any of Examples 1-2, the user interface interrogation component further configured to remove language-specific user interface control information from the user interface control information captured for the opened graphical user interface windows such that language-neutral user interface control information remains after removal of the language-specific user interface control information, and the user interface interrogation component further configured to generate the user interface fingerprint identifier based on the language-neutral user interface control information without the language-specific user interface control information.

### EXAMPLE 4

The computing system according to any of Examples 1-3, the execution evaluation component configured to capture the event log of the computer-executable application using a debugging engine.

### EXAMPLE 5

The computing system according to any of Examples 1-4, the event log being an application stack of the computer-executable application.

### EXAMPLE 6

The computing system according to any of Examples 1-5, the user interface fingerprint identifier being a first hash value based on the user interface control information, and the event fingerprint identifier being a second hash value based on the event log.

### EXAMPLE 7

The computing system according to any of Examples 1-6, the computer-executable application being configured to initiate the contextual fingerprinting system to determine the global fingerprint identifier that maps to the state of the computer-executable application.

### EXAMPLE 8

The computing system according to any of Examples 1-7, the contextual fingerprinting system further comprising an export component configured to transmit the global fingerprint identifier that maps to the state of the computer-executable application to a differing computing system.

### EXAMPLE 9

The computing system according to any of Examples 1-8, the global fingerprint identifier maps to a solution identifier that specifies a solution asset, the contextual fingerprinting system further comprising a presentation component configured to: retrieve the solution asset based on the global fingerprint identifier; and output the solution asset.

### EXAMPLE 10

The computing system according to any of Examples 1-9, the contextual fingerprinting system further comprising an interface component configured to: generate a query for execution by a capture store computing system, the query comprises the global fingerprint identifier; responsive to the execution of the query by the capture store computing system, receive a series of user interface captures from the capture store computing system, the series of the user interface captures being specified by a use case that corresponds to the state of the computer-executable application; and display the series of the user interface captures via a display screen.

### EXAMPLE 11

The computing system according to any of Examples 1-9, the contextual fingerprinting system further comprising an interface component configured to: generate a query for execution by a capture store computing system, the query comprises the global fingerprint identifier; responsive to the execution of the query by the capture store computing system, receive a user interface capture corresponding to the state of the computer-executable application and a list of use cases across the user interface capture; receive a selection of a particular use case from the list of use cases; responsive to the selection, receive a series of user interface captures specified by the particular use case, the series of user interface captures being received from the capture store computing system; and display the series of the user interface captures via a display screen.

### EXAMPLE 12

The computing system according to any of Examples 1-11, at least one of the opened graphical user interface windows comprises an error message, and the global fingerprint identifier specifies the state of the computer-executable application at a time that the computer-executable application outputted the error message.

### EXAMPLE 13

A capture store computing system, comprising: at least one processor; and computer-readable storage, comprising: user interface captures for a computer-executable application, a user interface capture comprises a screen capture of a graphical user interface window and metadata that specifies control properties for the graphical user interface window; use cases for the computer-executable application, wherein the use cases specify respective groups of the user interface captures; and a capture store management system being executable by the at least one processor, the capture store management system comprising: an access component configured to: receive a request for a use case; identify the use case based on the request; and responsive to the request, transmit a group of user interface captures specified by the use case identified based on the request.

### EXAMPLE 14

The capture store computing system according to Example 13, the request being a query that comprises a global fingerprint identifier that maps to a state of the computer-executable application, the access component configured to identify the use case based on the global fingerprint identifier.

### EXAMPLE 15

The capture store computing system according to Example 13, the request being a query, the access component further configured to: identify the user interface capture based on the query; identify a list of the use cases, each of the use cases in the list comprise the user interface capture; transmit the list of the use cases; receive an indication of a selection of the use case from the list of the use cases; and responsive to receipt of the indication of the selection of the use case, transmit the group of the user interface captures specified by the use case.

### EXAMPLE 16

The capture store computing system according to any of Examples 13-15, the metadata that specifies the control properties for the graphical user interface window comprise an identifier of a control included in the graphical user interface window, dependency information that indicates a condition to enable the control, and a name of the user interface capture.

### EXAMPLE 17

The capture store computing system according to any of Examples 13-16, the access component further configured to: receive a selection of the user interface capture from a user interface namespace tree, the user interface namespace tree comprises names of the user interface captures; identify a list of the use cases, each of the use cases in the list comprise the user interface capture; transmit the list of the use cases; receive a selection of the use case from the list of the use cases; and transmit the group of the user interface captures specified by the use case as selected.

### EXAMPLE 18

The capture store computing system according to any of Examples 13-17, the capture store management system further comprising an integration component configured to: receive at least a portion of the user interface captures for the computer-executable application and at least a portion of the use cases for the computer-executable application from a differing capture store computing system; and store the portion of the user interface captures for the computer-executable application and the portion of the use cases for the computer-executable application received from the differing capture store computing system in the computer-readable storage.

### EXAMPLE 19

The capture store computing system according to any of Examples 13-18, the capture store management system further comprising an authoring component configured to: create a differing use case for the computer-executable application, the differing use case specifies a subset of the user interface captures; and store the differing use case for the computer-executable application as part of the use cases in the computer-readable storage.

### EXAMPLE 20

A method of controlling presentation of a use case based on a state of a computer-executable application, comprising: determining a global fingerprint identifier that maps to the state of the computer-executable application, the global fingerprint identifier being determined based on opened graphical user interface windows of the computer-executable application and an event log of the computer-executable application; generating a query for execution by a capture store computing system, the query comprises the global fingerprint identifier; responsive to the execution of the query by the capture store computing system, receiving a series of user interface captures from the capture store computing system, the series of the user interface captures being specified by the use case, the use case corresponds to the state of the computer-executable application; and displaying the series of the user interface captures via a display screen.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something.”

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A computing system, comprising:
at least one processor; and
computer-readable storage comprising a contextual fingerprinting system configured to evaluate a state of a computer-executable application, the contextual fingerprinting system being executable by the at least one processor, the contextual fingerprinting system comprising:
a user interface interrogation component configured to:
capture user interface control information for opened graphical user interface windows of the computer-executable application during execution of the computer-executable application; and
generate a user interface fingerprint identifier based on the user interface control information;
an execution evaluation component configured to:
capture an event log of the computer-executable application during the execution of the computer-executable application; and
generate an event fingerprint identifier based on the event log; and
a mapping component configured to determine a global fingerprint identifier that maps to the state of the computer-executable application based on the user interface fingerprint identifier and the event fingerprint identifier.

2. The computing system of claim 1, the user interface control information comprises control tree structure information for the opened graphical user interface windows and information that specifies properties of controls in the opened graphical user interface windows.

3. The computing system of claim 1, the user interface interrogation component further configured to remove language-specific user interface control information from the user interface control information captured for the opened graphical user interface windows such that language-neutral user interface control information remains after removal of the language-specific user interface control information, and the user interface interrogation component further configured to generate the user interface fingerprint identifier based on the language-neutral user interface control information without the language-specific user interface control information.

4. The computing system of claim 1, the execution evaluation component configured to capture the event log of the computer-executable application using a debugging engine.

5. The computing system of claim 1, the event log being an application stack of the computer-executable application.

6. The computing system of claim 1, the user interface fingerprint identifier being a first hash value based on the user interface control information, and the event fingerprint identifier being a second hash value based on the event log.

7. The computing system of claim 1, the computer-executable application being configured to initiate the contextual fingerprinting system to determine the global fingerprint identifier that maps to the state of the computer-executable application.

8. The computing system of claim 1, the contextual fingerprinting system further comprising an export component configured to transmit the global fingerprint identifier that maps to the state of the computer-executable application to a differing computing system.

9. The computing system of claim 1, the global fingerprint identifier maps to a solution identifier that specifies a solution asset, the contextual fingerprinting system further comprising a presentation component configured to:
retrieve the solution asset based on the global fingerprint identifier; and
output the solution asset.

10. The computing system of claim 1, the contextual fingerprinting system further comprising an interface component configured to:
generate a query for execution by a capture store computing system, the query comprises the global fingerprint identifier;
responsive to the execution of the query by the capture store computing system, receive a series of user interface captures from the capture store computing system, the series of the user interface captures being specified by a use case that corresponds to the state of the computer-executable application; and
display the series of the user interface captures via a display screen.

11. The computing system of claim 1, the contextual fingerprinting system further comprising an interface component configured to:
generate a query for execution by a capture store computing system, the query comprises the global fingerprint identifier;
responsive to the execution of the query by the capture store computing system, receive a user interface capture corresponding to the state of the computer-executable application and a list of use cases across the user interface capture;
receive a selection of a particular use case from the list of use cases;
responsive to the selection, receive a series of user interface captures specified by the particular use case, the series of user interface captures being received from the capture store computing system; and
display the series of the user interface captures via a display screen.

12. The computing system of claim 1, at least one of the opened graphical user interface windows comprises an error message, and the global fingerprint identifier specifies the state of the computer-executable application at a time that the computer-executable application outputted the error message.

13. A capture store computing system, comprising:
at least one processor; and
computer-readable storage, comprising:
user interface captures for a computer-executable application, a user interface capture comprises a screen capture of a graphical user interface window and metadata that specifies control properties for the graphical user interface window;
use cases for the computer-executable application, wherein the use cases specify respective groups of the user interface captures; and
a capture store management system being executable by the at least one processor, the capture store management system comprising:
an access component configured to:
receive a request for a use case;
identify the use case based on the request; and
responsive to the request, transmit a group of user interface captures specified by the use case identified based on the request.

14. The capture store computing system of claim 13, the request being a query that comprises a global fingerprint identifier that maps to a state of the computer-executable application, the access component configured to identify the use case based on the global fingerprint identifier.

15. The capture store computing system of claim 13, the request being a query, the access component further configured to:
identify the user interface capture based on the query;
identify a list of the use cases, each of the use cases in the list comprise the user interface capture;
transmit the list of the use cases;
receive an indication of a selection of the use case from the list of the use cases; and
responsive to receipt of the indication of the selection of the use case, transmit the group of the user interface captures specified by the use case.

16. The capture store computing system of claim 13, the metadata that specifies the control properties for the graphical user interface window comprise an identifier of a control included in the graphical user interface window, dependency information that indicates a condition to enable the control, and a name of the user interface capture.

17. The capture store computing system of claim 13, the access component further configured to:
receive a selection of the user interface capture from a user interface namespace tree, the user interface namespace tree comprises names of the user interface captures;
identify a list of the use cases, each of the use cases in the list comprise the user interface capture;
transmit the list of the use cases;
receive a selection of the use case from the list of the use cases; and
transmit the group of the user interface captures specified by the use case as selected.

18. The capture store computing system of claim 13, the capture store management system further comprising an integration component configured to:
receive at least a portion of the user interface captures for the computer-executable application and at least a portion of the use cases for the computer-executable application from a differing capture store computing system; and
store the portion of the user interface captures for the computer-executable application and the portion of the use cases for the computer-executable application received from the differing capture store computing system in the computer-readable storage.

19. The capture store computing system of claim 13, the capture store management system further comprising an authoring component configured to:
create a differing use case for the computer-executable application, the differing use case specifies a subset of the user interface captures; and
store the differing use case for the computer-executable application as part of the use cases in the computer-readable storage.

20. A method of controlling presentation of a use case based on a state of a computer-executable application, comprising:
determining a global fingerprint identifier that maps to the state of the computer-executable application, the global fingerprint identifier being determined based on opened graphical user interface windows of the computer-executable application and an event log of the computer-executable application;
generating a query for execution by a capture store computing system, the query comprises the global fingerprint identifier;
responsive to the execution of the query by the capture store computing system, receiving a series of user interface captures from the capture store computing system, the series of the user interface captures being specified by the use case, the use case corresponds to the state of the computer-executable application; and
displaying the series of the user interface captures via a display screen.
